(19) United States
(12) Patent Application Publication
(10) Pub. No.: US 2008/0228511 A1
(43) Pub. Date: Sep. 18, 2008

(54) REVENUE OPTIMIZATION SYSTEM AND METHOD

(76) Inventor: Bart J. Barden, Seattle, WA (US)

Correspondence Address: AXIOS LAW GROUP. PLLC, 1525 FOURTH AVENUE, SUITE 800, SEATTLE, WA, 98101, US

(21) Appl. No.: 11/871,946

(22) Filed: Oct. 12, 2007

Related U.S. Application Data
(60) Provisional application No. 60/829,270, filed on Oct. 12, 2006.

(51) Int. Cl. G06Q 10/00

(52) U.S. Cl. 705/1

(57) ABSTRACT

A revenue optimization system and method are provided herein.

### RELATED REFERENCES

This application claims priority to U.S. Provisional Application 60/829,270 filed Oct. 12, 2006. The foregoing application is hereby incorporated by reference in its entirety as if fully set forth herein.

### BACKGROUND

There are several limitations related to wagering on sporting events in conventional systems. One limitation is the lack of flexibility in the type of wagers that can be offered. The lack of flexibility has been due to increased risk in attempting to handicap wagering options properly. Another limitation is the lack of computing power which is applied to handicapping and optimization of point spread/line or wager movement. This has been due to the manual nature and lack of computing power or systems applied to this space. A further inefficiency with sports wagering is that overall revenue is being generated by attempting to balance betting activity evenly on both sides of a wagers outcome. Currently, balanced between is one efficient but manual risk management method. An additional limitation is the inability to evaluate revenue optimization and risk tolerance on a holistic level not on an individual handicapped event, sport or week level. Yet another limitation is the inability to create the efficient betting events and products to customers due to lack of relevant personal data inputs.

Market Conditions:

Market conditions in handicapping and wagering are at a point of change. Technology advancements in how wagers and handicapped events are actually consumed, (in the form of web-based, mobile-based and also traditional sports book locations) but few of the other web-based user and advertising optimization technologies are being applied to what handicapped events are offered and used. Today normal consumption of a handicapped event is to go to a casino in Las Vegas, verify the handicap on the event you are looking to wager on and place a monetary bet on the outcome. The current way handicapping is done is set by a group of expert human beings per single event, and then the handicap can change on a per establishment basis depending on volume of activity occurring specifically at the event or venue.

### DETAILED DESCRIPTION

One opportunity for improving handicapping includes extending web based and internet technology not only to the front-end side of handicapping events, but also to the back-end data processing components. Such back end technology becomes more important as traditional gaming establishments implement more computer-based information handling technologies.

One example embodiment includes yield optimization software and a delivery engine with the purpose to increase the yield, accuracy and reduction of risk when offering betting or handicapping opportunities via trending and data analysis. This embodiment may use automated systems and computer power to perform complex and detailed calculations, generating conclusions that will minimize conventional limitations in real or near real-time. Such a system may act as middleware to integrate with existing and future platforms, websites, devices, and system infrastructures related to games of chance that handicap specific event results. For the purposes of documentation these event results will be called “lines,” “handicapping events” or “points” throughout this document. One example system uses three components to accomplish this goal:
(1) Optimization Engine, including data inputs
(2) API Conversion System and Data Output
(3) Reporting and Control System

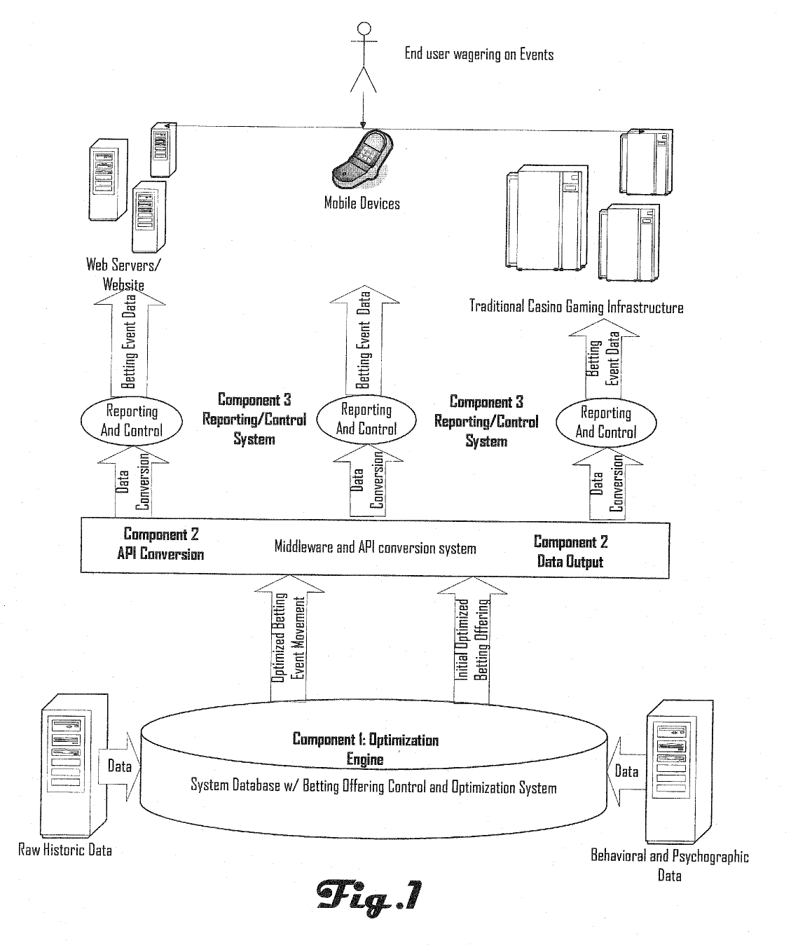

FIG. 1:

Component 1: Optimization Engine

Component 1 is the optimization engine (“OE”) itself. The OE is designed to set the optimal or profit-maximizing result for all current and upcoming events. The OE takes input information on current and expected behavior of the users of the system. Based on this input, the OE uses a set of algorithms to compute the expected financial or yield maximizing outcome of bet lines or point spreads. The OE then sets the line or handicap for the series of events in question at the optimal level and makes real-time adjustments as new and better information becomes available. The goal of this system is to provide the logic necessary for optimization.
(1) The OE is comprised of 5 systems:
(2) Financial Exposure Tracking System (“FETS”)
(3) Trend Monitoring System (“TMS”)
(4) Predictive Modeling System—User History Based (“PMHB”)
(5) Predictive Modeling System—User Behavior Based (“PMBB”)
(6) Predictive Modeling System—Expert Optimization (“PMEO”)

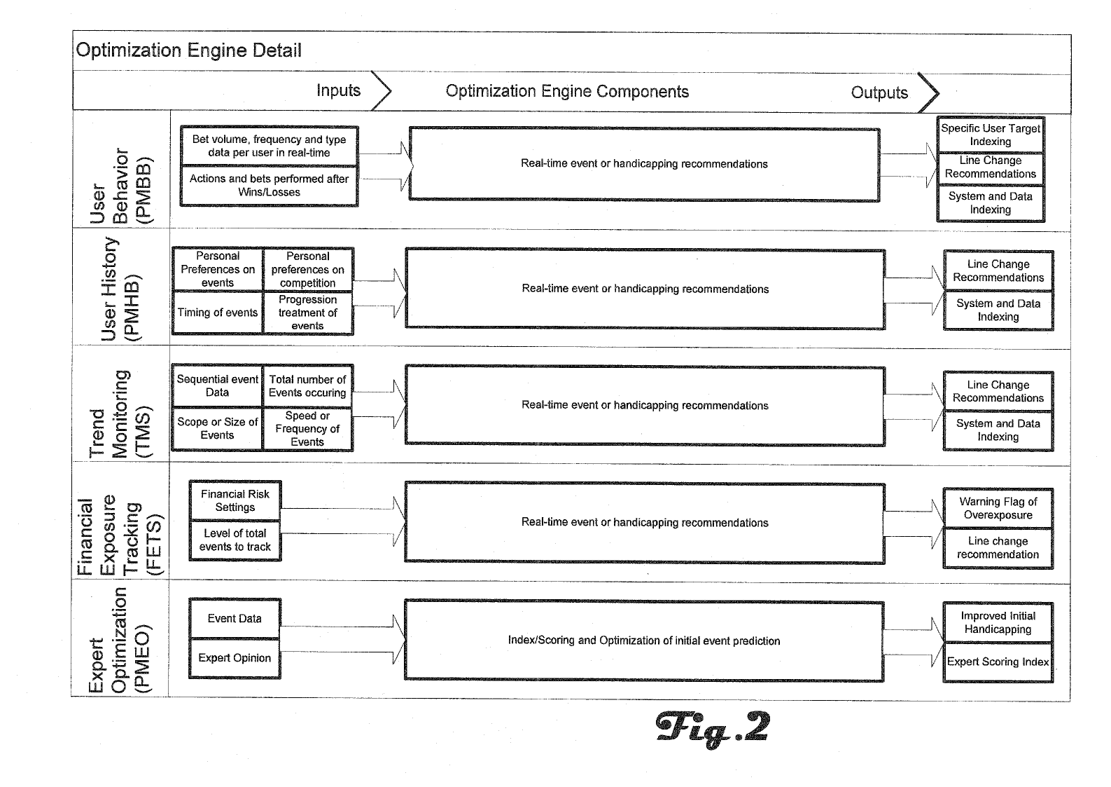

FIG. 2: Financial Exposure Tracking System

The first component of the OE is the FETS. At the most basic level, the OE monitors the current set of bets placed on each open handicapped event and calculates in real time the financial risk being carried by the system owner/user. The engine does this be performing a series of “what if” calculations. For example, if Team X exceeds the established handicapped event setting or point spread, how much money would the system owner or “House” have to pay out, given the number of people that believe in outcome A versus outcome B.

The majority of systems today only look to optimize a single outcome versus looking to optimize yield revenue over the entire set of events. The FETS system looks to optimize over every event outcome not as independent events but joined and related events.

Trend Monitoring System

The second component of the OE is the TMS. The FETS can be considered a “fail-safe” risk management tool. It keeps the House from exceeding a given level of exposure but does not prevent that level of exposure from occurring. To minimize the likelihood of the House reaching its maximum exposure level, a TMS will be introduced that analyzes trends within the incoming events and identifies cues that suggest a given handicapped event may not be set at its optimal level.

The TMS is premised on the understanding that analysis of early patterns can be informative of the final distribution of the universe on a given event. In the earlier example, if the optimal handicap for Athlete X were set at 21 points and the first seven events to arrive into the system were universally in one direction this would suggest that the bettors had superior knowledge to the House and had high confidence that the Athlete would exceed the 21 point handicap. As long as it can be proved that this pattern represents a statistically significant trend and that it was not an anomaly, the House can make more informed decisions when looking to alter the point or line, even before the FETS flagged this line as a source of risk. In this respect, the TMS tool can be seen as an “Early Warning System” minimizes the number of times that the exposure tracking system is required to activate and identify a line generating high exposure. The outcome is that the BTMS system provides additional yield optimization for the OE system user.

Predictive Modeling System—History Based (PMHB)

The third component of the OE is the PMHB. The FETS and TMS systems just described are powerful risk management tools but they are largely reactive in nature meaning they make adjustments to the line structure based on the most recent user behavior. These systems are enhanced by overlaying a predictive modeling system that anticipates likely user behavior by mining the historical behavior of these users. This is the PMHB system.

One benefit of the overall OE system is the ability to compile data on a user's past behavior. Because a user must sign-in to use most online systems it is possible to associate behavioral data with a specific individual or user ID and to reference that data every time the user comes on line.

Examples of the types of behavior that could be predicted based on past history are:
Likelihood to interact, select or wager on a given athlete, team or event
Likelihood to bet on a given athlete, team or event based on the competitive context. For example always bet on the Red Sox when they playing the Yankees
Likelihood to bet on specific classes of competitions or events
Likelihood to take consistent positions
Average number of bets in a given betting session
Average size of bets
Average size progression in a given betting session
Timing of bet placements

Predictive Modeling System—User Behavior Based (PMBB)

The fourth component of the OE is the PMBB. Once efficient data can be amassed, the PMBB can be leveraged. The PMBB tool is predicated on return visits. The effectiveness and value of the PMBB increases as the number of times the same users make wagers and use the system.

The PMBB is the ability to predict behavior on personal and user based favorites. This system finds patterns and predicts behavior based on personal preferences such as favorite team, sport, season, or their betting situation.

This system would actually add a predictive layer at the specific user level.

Predictive Modeling System—Expert Inputs (PMEI)

The fifth component of the OE is the PMEI. This system would be the ability to optimize on level of success from individual handicappers and other optimized or handicapping systems.

This system would function as a check and balance for our predictive system. The example of use would be like a review system. The OE system would perform various calculations using the previous components described. These calculations would be placed in a staging or preview area that could then be washed against some additional data inputs. If certain thresholds, variances or differences appeared the system could adjust the final production-ready calculations

Component 2: API and Conversion System

The API and data conversion system exists to enable compatibility of the OE with media devices and external system platforms. Compatibility includes both enabling existing predictive data input as well as the integration of the overall system with customers existing infrastructure. The goal of this component is to allow the system to plug into as many existing and new infrastructures and devices. While Mobile, Mainframe and Web infrastructure are discussed herein, the overall system is not limited to these embodiments.

The API and Conversion system provides all necessary conversion, plug-in, data translation and system interfaces for real time synchronization and use of the overall system by all customers, including:
General synchronization and integration
Integration for legacy and Mainframe platforms
Integration for web-based platforms and systems
Integration for Mobile Applications and platforms

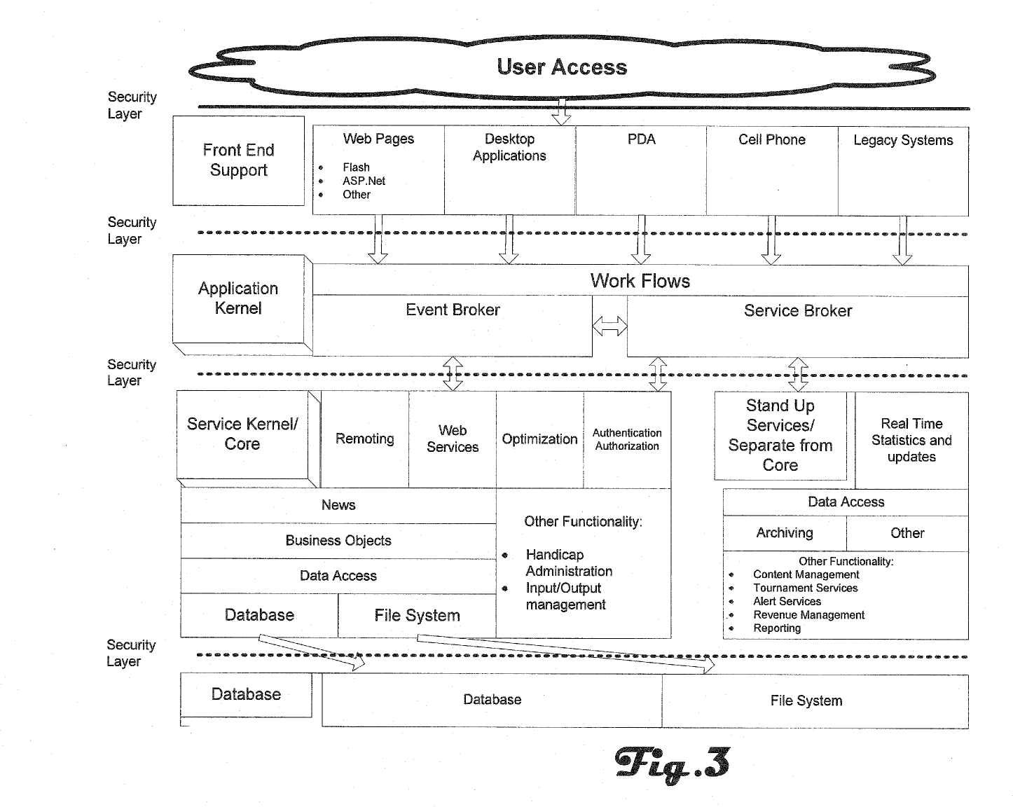

FIG. 3: Overall System Platform

General Integration

The general integration component of the API and Conversion System does the necessary basic data conversion and provides the necessary system connections to plug into all database architecture types. The system will leverage XML, Object Models and existing database technologies to enable and ensure that the optimization is occurring in real-time. The system will support customers using the overall platform or their own infrastructure. Various embodiments may use service-oriented architecture. Remoting systems at the middle tier level may be used so any type of data or content consumption can be used.

Legacy and Mainframe Platforms

The legacy and mainframe component of the system comprise the Object Model, execution files, database structure and client software plug-ins and code. These objects work together to provide real time data communication, sharing and manipulation necessary to optimize setting of the event line. There are 2 main parts of this component; the client-side software necessary to pull necessary data and the server-side software and technology necessary to push, analyze and manipulate results. The key difference of this system is the need for legacy data support.

Various embodiments may leverage a “Service Oriented Architecture” to enable n-tier platform support. The system may be self-contained and be able to plug into various systems once the API library is established

Web-Based Platforms and Systems

The web-based component of the system consists of the Object Model, execution files, database structure and client software plug-ins and code. These objects work together to provide real time data communication, sharing and manipulation necessary to optimize setting of the event line. There are 2 main parts of this component; the client-side software necessary to pull necessary data and the server-side software and technology necessary to push, analyze and manipulate results. One difference of this system includes being able to provide a full-service white labeled product offering for clients that wish to keep systems in-house.

Various embodiments may globally leverage a Service Oriented Architecture to enable *n-tier* platform support. The system will be self-contained and be able to plug into any system once the API library is established

Mobile Platforms and Systems

The mobile platform component of the system consists of the Object Model, execution files, database structure and client software plug-ins and code. These objects work together to provide real time data communication, sharing and manipulation necessary to optimize setting of the event line. There are 2 main parts of this component; the client-side software necessary to pull necessary data and the server-side software and technology necessary to push, analyze and manipulate results. The key difference of this system is having multiple code sets to support the different mobile devices such as PDA, cell phone or custom wireless device. Various embodiments utilize handset agnostic technologies and protocols to achieve scale. WAP-based and Windows Mobile 5.0 are some of such technologies.

Various embodiments may leverage a Service Oriented Architecture to enable *n-tier* platform support. The system will be self-contained and be able to plug into any system once the API library is established

Component 3: Reporting and Control System

The reporting and control system provides the clients and customers with the necessary reporting information and data to evaluate if the system is performing correctly. If there are requested adjustments to the recommended outputs or optimized results this component also provides a way for manual adjustments, edits or inputs that are not yet part of the overall system. One goal of this component is to give the users of

The TMS accomplishes this by mining historical betting data to understand which trending characteristics represented a situation in which the actual outcome was different than the initial predicted outcome. Variables that are considered in mining the historical betting data include the following:
Number of sequential bets that are consistently “Over” or “Under” the established Point
Size of bets placed on “Over” or “Under” positions (as compared to the historical mean sizes)
Total number of bets attracted by a given Athlete or Team (as compared to the historical mean)
Speed with which the above bets arrive (e.g. with what frequency and how long before an event begins)

The TMS algorithm will “learn” as the historical set of data grows and provides richer information for training the algorithm, e.g., using one or more learning neural network algorithms. Over time, it will become sufficiently sophisticated to identify trends not only in the aggregate but as pertains to specific competitive situations such as finding out that there are a higher volume of bets than usual on the Bears-Eagles game and adjusting as quickly as possible.

Analysis of historical data will enable the House to understand, at any point in time, the likely profile of future bets and revise its exposure assessment accordingly.

Taking the example above, the House might know that there is a pool of betters who are fans of Athlete X and who consistently place large bets on this athlete and tend to take an Over position (a sort of morale support). Knowing this, the House could calculate not just the current exposure on Athlete X but the expected future exposure based on the probability (statistically determined) that the additional betters will move in.

For example, although the exposure on Line 1 is only $250 after the first five bets have been posted, the House might now that there is a 50% likelihood (based on historical behaviors) that 3 of the “fans” of Athlete X will place bets of roughly $100 in an Over position. As a result, the expected exposure for this line can be treated as the system ultimate control and flexibility into how the system outputs and recommendations are actually applied to their infrastructure or business.

Various embodiments may be able to do real-time reporting and system administration based on event-based logging. Any event logging will be specific to the customer, client, platform and goals.

Additionally the system can be integrated into legacy systems to actually control the handicapping versus just recommend. We will have the interfaces and designs established (working with clients) to make this happen given the flexibility and scale of the system.

### EXAMPLE

Client A could program the system to optimize line setting based on potential revenue optimization of 5%. This means that the system would go through a series of predictions and recommendations arriving at the best guess.

Client B could program the system to exclude certain games or users in the prediction. They may only want to use the system to optimize a subset of the events to test the system out for example.

### WORKFLOW EXAMPLE

### Financial Exposure Tracking System (FETS)

The example below helps to illustrate how the FETS system functions

In this example, only one line is open (on Athlete X) and the House has set the initial point at 21. This means that without any other information the FETS system believes that 21 is the optimal event outcome. The following series of bets then arrives:

TABLE 1

| LINE 1 | | | | |
|---|---|---|---|---|
| Athlete = X | Athlete | 1 | Key | 11 |
| Point = 21 | | | | |

| Bet | Bet | Posi- | | Tot. | Tot. | Expo- | To | |
|---|---|---|---|---|---|---|---|---|
| In? | # | tion | Amount | Over | Under | sure | the | Decision |
| y | 1 | Over | 200 | 200 | 0 | 200 | Over | Continue |
| y | 2 | Over | 199 | 399 | 0 | 399 | Over | Continue |
| y | 3 | Under | 150 | 399 | 150 | 249 | Over | Continue |
| y | 4 | Over | 180 | 579 | 150 | 429 | Over | Continue |
| y | 5 | Under | 179 | 579 | 329 | 250 | Over | Continue |

The first bet that arrives is $200 to the Over meaning that the House will pay out $200 if Athlete X scores more than 21 points. The second bet to arrive is also to the Over, increasing the House's exposure to $399 if Athlete X scores above 21. The third bet, however, takes an Under position for $150. This means that even if Athlete X beats the point, the House's net loss is only $249 ($399 paid out on Bets 1 and 2, less the $150 taken in on Bet 3). This calculation is repeated as each new bet arrives, ensuring that the House is constantly aware of the financial exposure it bears on each open line. Note that, in the interest of simplicity, all bet figures in this example are stated net of the 5-10% betting commission that the House normally takes.

In reality, multiple lines are open at any given time and so the OE tracks individual line-level exposure and sums these figures into an aggregate exposure figure. Based on this, the engine calculates the amount the House would lose in a worst-case out scenario in which every open line had the most unfavorable outcome for the institution using the OE system. This real-time calculation enables the House to monitor its aggregate financial exposure at every given point in time.

Beyond simply calculating exposure, the OE has “business rules” that indicate what level of exposure is acceptable to the House and at what level of exposure the engine should undertake some actions to mitigate risk.

Table 2 illustrates this concept. In this scenario, the House has determined that it is prepared to bear up to $850 of aggregate exposure at any point in time on the open lines. This simplified example assumes that only two lines are open.

The acceptable exposure level is reflected in row one of the Risk Analysis matrix. Row two tracks the aggregate exposure across all open lines at each point in time. In this example, five bets have been placed on line one generating a line-level exposure of $250. Five bets have allows been placed on line two, rendering an exposure level of $622. The aggregate exposure is thus $872, which exceeds the level determined by the House to be acceptable.

Based on this determination, the OE will undertake one of two decisions; First it can close the line(s) generating the highest level of exposure, in this example Line 2 or it can re-set the point on the line(s) generating the greatest level of exposure. The new point will be determined based trends observed in recent bets on the line in question and/or predictive modeling based on historical user behavior.

TABLE 2
Risk Analysis

| | |
|---|---|
| 1. Acceptable Exposure | $850 |
| 2. Aggregate Current Exposure | $872 |
| 3. Delta | −$22 |

| LINE 1 | | | | |
|---|---|---|---|---|
| Athlete = X | Athlete | 1 | Key | 11 |
| Point = 21 | | | | |

| Bet | Bet | Posi- | | Tot. | Tot. | Expo- | To | |
|---|---|---|---|---|---|---|---|---|
| In? | # | tion | Amount | Over | Under | sure | the | Decision |
| y | 1 | Over | 200 | 200 | 0 | 200 | Over | Continue |
| y | 2 | Over | 199 | 399 | 0 | 399 | Over | Continue |
| y | 3 | Under | 150 | 399 | 150 | 249 | Over | Continue |
| y | 4 | Over | 180 | 579 | 150 | 429 | Over | Continue |
| y | 5 | Under | 179 | 579 | 329 | 250 | Over | Continue |

TABLE 3
LINE 2

| | | | | |
|---|---|---|---|---|
| Athlete | Athlete | 1 | Key | 21 |
| Point | | | | |

| Bet | Bet | Posi- | | Tot. | Tot. | Expo- | To | |
|---|---|---|---|---|---|---|---|---|
| In? | # | tion | Amount | Over | Under | sure | the | Decision |
| y | 1 | Under | 101 | 0 | 101 | 101 | Under | Continue |
| y | 2 | Under | 202 | 0 | 303 | 303 | Under | Continue |
| y | 3 | Under | 119 | 0 | 422 | 422 | Under | Continue |
| y | 4 | Over | 150 | 150 | 422 | 272 | Under | Continue |
| y | 5 | Under | 350 | 150 | 772 | 622 | Under | Close |

It is important to note that although the mathematics for calculating the House's exposure are relatively simple, such calculations are difficult to accomplish manually due to the speed and frequency require by real-time optimization. The OE system provides efficient server capacity, computation and technologies that are required in order for the calculations to be made quickly enough to meaningfully manage risk.

Betting Trend Monitoring System $400 to the Over ($250 from existing bets+(0.5*3*100)). If however, the five existing bets already included the three “fans”, the system would not include the additional exposure from expected behavior.

Although specific embodiments have been illustrated and described herein, it will be appreciated by those of ordinary skill in the art that a whole variety of alternate and/or equivalent implementations may be substituted for the specific embodiments shown and described without departing from the scope of the present invention. This application is intended to cover any adaptations or variations of the embodiments discussed herein.

1. A revenue optimization system and method as shown and described.
